(19) United States
(12) Patent Application Publication
(10) Pub. No.: US 2007/0129036 A1
(43) Pub. Date: Jun. 7, 2007

(54) Method and apparatus to reconstruct a high frequency component

(75) Inventor: Manish Arora, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/586,544

(22) Filed: Oct. 26, 2006

(30) Foreign Application Priority Data
Nov. 28, 2005 (KR) 2005-114047

(51) Int. Cl. G10K 11/16; H04B 1/16

(52) U.S. Cl. 455/205; 381/71.12; 381/71.1

(57) ABSTRACT

A method and apparatus to restore a high frequency component. A correlation between an input signal and previously stored noise samples is obtained and a bandwidth of the input signal is detected according to the correlation. The detected input signal bandwidth is split into a predetermined number of sub-bands. A level of high frequency sub-band signals generated by performing a predetermined nonlinear operation on the split sub-bands is controlled in response to energy levels of the high frequency sub-bands to obtain restored signals. The restored signals and the input signal are combined to generate a target audio signal.

### CROSS-REFERENCE TO RELATED APPLICATIONS

This application claims the benefit of Korean Patent Application No. 10-2005-0114047, filed on Nov. 28, 2005, in the Korean Intellectual Property Office, the disclosure of which is incorporated herein in its entirety by reference.

### BACKGROUND OF THE INVENTION

1. Field of the Invention

The present general inventive concept relates to an audio coding technique, and more particularly, to a method and apparatus to reconstruct a high frequency component of an encoded audio signal.

2. Description of the Related Art

Audio CODECs (coder-decoders) such as MP3 (MPEG1 audio layer 3) use a technique of removing a component that is not important to human hearing from an audio signal, that is, a high frequency component. However, the high frequency component contributes to the quality of the audio signal and supplements liveliness of sound. Thus, the high frequency component should be maintained or appropriately restored in order to obtain a high quality audio sound. Accordingly, the MP3 PRO CODEC that improves the conventional MP3 CODEC has been developed. However, application of the MP3 PRO CODEC requires drastic improvement of a decoder as well as an encoder.

FIG. 1 is a block diagram illustrating a conventional apparatus that restores a high frequency component from an audio signal from which the high frequency component has been removed by lossy audio compression. Referring to FIG. 1, a first filter 100 extracts a high frequency component from an input signal. A nonlinear device NLD 110 generates a harmonic signal. A second filter 120 filters the harmonic signal to generate an appropriate spectrum. A gain controller G 130 controls the level of the spectrum. A delay 140 controls the phase of the input signal to be in-phase with a signal corresponding to the spectrum output from the gain controller G 130. The input signal with the controlled phase is combined with the signal corresponding to the spectrum to generate an output signal.

The nonlinear device 110 consists of a full wave rectifier and a full wave integrator. FIGS. 2 and 3 illustrate output signals of the full wave rectifier and the full wave integrator, respectively.

Referring to FIGS. 2 and 3, when an input signal 200 (300 in FIG. 3) is a sine wave signal having a specific frequency f0, the output signal 210 (310 in FIG. 3) of the full wave rectifier includes several harmonic signals. The output signal 220 (320 in FIG. 3) of the full wave integrator becomes a high frequency signal evenly including high frequency bands higher than the frequency band of the input signal.

However, the conventional high frequency component restoring apparatus should use an adaptive filter having a complicated structure, because it does not separately detect the bandwidth of an input signal. Thus, it is difficult to construct the conventional high frequency component restoring apparatus. Furthermore, a gain used when the gain of a restored audio signal is controlled has a fixed value, and thus the restored audio signal has quality that is below average and the shape or slope of a spectrum envelope cannot accord with an original audio signal.

### SUMMARY OF THE INVENTION

The present general inventive concept provides a high frequency component restoring method to accurately detect a bandwidth of an input signal with a simple device construction and to perform optimized signal processing on the detected input signal bandwidth to restore a lost high frequency component, thereby improving audio quality of the input signal.

The present general inventive concept also provides a high frequency component restoring apparatus employing the high frequency component restoring method.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a method of restoring a high frequency component of an audio signal, the method including obtaining a correlation between an input signal and previously stored noise samples and detecting a bandwidth of the input signal according to the correlation, splitting the detected input signal bandwidth into a predetermined number of sub-bands, controlling a level of high frequency sub-band signals generated by performing a predetermined nonlinear operation on the split sub-bands, in response to energy levels of the high frequency sub-bands to obtain restored signals, and combining the restored signals and the input signal to generate a target audio signal.

The foregoing and/or other aspects of the present general inventive concept may also be achieved by providing a computer readable recording medium storing a program executing the high frequency component restoring method in a computer.

The foregoing and/or other aspects of the present general inventive concept may also be achieved by providing an apparatus to restore a high frequency component of an audio signal, the apparatus including a signal bandwidth detector to obtain a correlation between an input signal and previously stored noise samples and to detect a bandwidth of the input signal according to the correlation, a sub-band filter to split the detected input signal bandwidth into a predetermined number of sub-bands, a restored signal generator to control a level of high frequency sub-band signals generated by performing a predetermined nonlinear operation on the split sub-bands, in response to energy levels of the high frequency sub-bands to obtain restored signals, and a signal combiner to combine the restored signals and the input signal to generate a target audio signal.

The sub-bands may have only high frequency components that are higher than a center frequency (corresponding to half of the input signal bandwidth) of the input signal bandwidth.

The apparatus to restore a high frequency component of an audio signal may be applied to a portable audio player.

The apparatus to restore a high frequency component of an audio signal may be applied to an audio reproducing device using an audio compression CODEC having a high frequency component loss.

The foregoing and/or other aspects of the present general inventive concept may also be achieved by providing a high frequency restoring apparatus, including a signal bandwidth detector to detect a signal bandwidth of an input audio signal, and a restored signal generator to derive a high frequency band from audio data in the detected signal bandwidth and to adjust a shape of a spectrum of the high frequency band to match a spectrum envelope of the input audio signal.

The foregoing and/or other aspects of the present general inventive concept may also be achieved by providing a portable audio player, including a high frequency component restoring apparatus to receive an input audio signal, to calculate a bandwidth of the input audio signal by comparing predetermined noise patterns with a frequency spectrum of the input audio signal, to derive high frequency sub bands above a center frequency of the input audio signal by applying a nonlinear operation to sub bands in the bandwidth of the input audio signal, and to adjust a level of the high frequency sub band signals in response to energy levels of the high frequency sub bands to provide a high frequency component, and an output part to combine the input audio signal with the high frequency component and output the combined audio signal.

The foregoing and/or other aspects of the present general inventive concept may also be achieved by providing a coder-decoder apparatus, including a high frequency component restoring apparatus to receive an input audio signal, to calculate a bandwidth of the input audio signal by comparing predetermined noise patterns with a frequency spectrum of the input audio signal, to derive high frequency sub bands above a center frequency of the input audio signal by applying a nonlinear operation to sub bands in the bandwidth of the input audio signal, and adjusting a level of the high frequency sub band signals in response to energy levels of the high frequency sub bands to provide a high frequency component, and an output part to combine the input audio signal with the high frequency component and output the combined audio signal.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a block diagram illustrating a conventional apparatus that restores a high frequency component of an audio signal;

FIGS. 2 and 3 illustrate output signals of a full wave rectifier and a full wave integrator, respectively, of a nonlinear device of the conventional high frequency component restoring apparatus of FIG. 1;

FIG. 4A is a block diagram illustrating an apparatus to restore a high frequency component of an audio signal according to an embodiment of the present general inventive concept;

FIG. 4B is a block diagram illustrating a harmonic processor of the high frequency component restoring apparatus of FIG. 4A;

FIG. 5 is a flow chart illustrating a method of restoring a high frequency component of an audio signal according to an embodiment of the present general inventive concept;

FIG. 6A is a flow chart illustrating an operation 500 of the high frequency component restoring method of FIG. 5;

FIG. 6B is a flow chart illustrating an operation 520 of the high frequency component restoring method of FIG. 5;

FIG. 6C is a flow chart illustrating an operation 625 of FIG. 6B;

FIG. 6D is a flow chart illustrating an operation 530 of the high frequency component restoring method of FIG. 5;

FIG. 7 is a graph illustrating signals used in the operation 500 of the high frequency component restoring method of FIG. 5.

FIG. 8 is a graph illustrating signals used in the operations 510 and 520 of the high frequency component restoring method of FIG. 5; and

FIG. 9 is a graph illustrating a restored audio signal obtained according to an embodiment of the present general inventive concept.

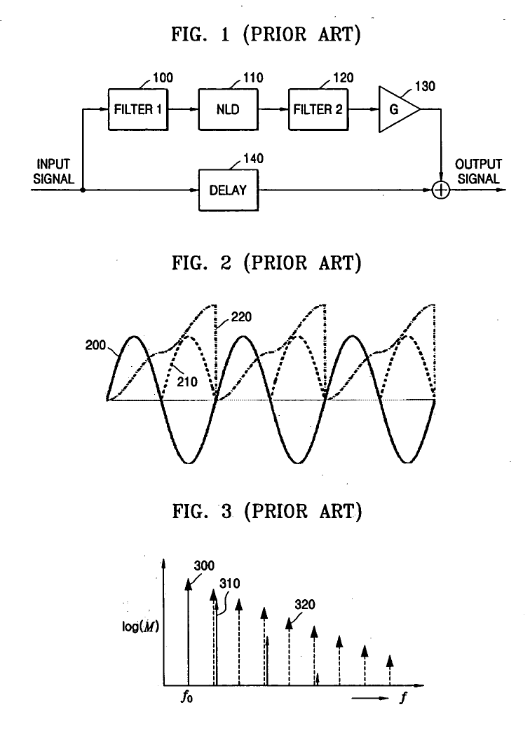

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

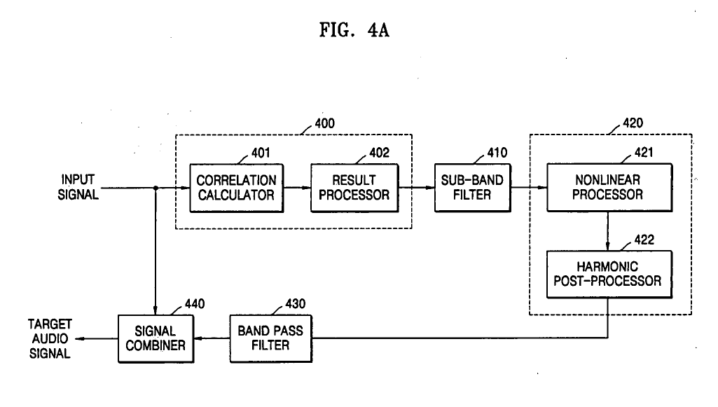

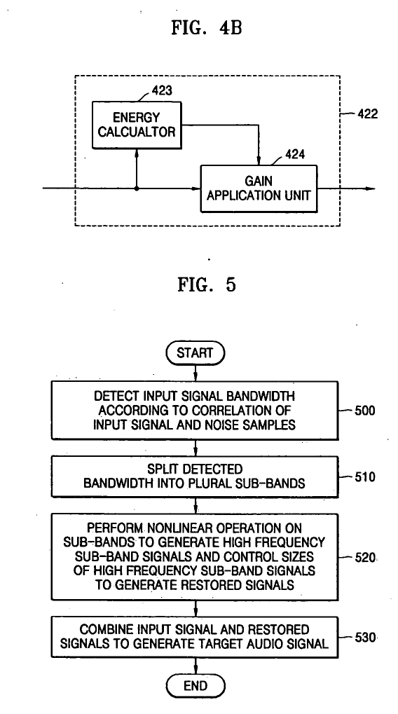

FIG. 4A is a block diagram illustrating an apparatus to restore a high frequency component of an audio signal according to an embodiment of the present general inventive concept. Referring to FIG. 4A, a signal bandwidth detector 400 obtains a correlation between an input signal and previously stored noise samples, and detects a bandwidth of the input signal according to the correlation. The noise samples are obtained by splitting general white noise into signals each having a predetermined bandwidth. That is, the noise samples are irrelevant to the input signal.

The signal bandwidth detector 400 may include a correlation calculator 401 and a result processor 402. The correlation calculator 401 calculates the correlation of the input signal and the previously stored noise samples. The result processor 402 determines areas where the correlation is less than a reference value as areas (i.e., first areas) with no audio signal frequencies, and determines areas (i.e., second areas) where the correlation is greater than the reference value as areas with audio signal frequencies. The result processor 402 may be designed such that a boundary between the areas with the audio signal frequencies and the areas with no audio signal frequencies is determined as the bandwidth of the input signal. As described above, the input signal bandwidth can be correctly detected with a simple device construction by using the correlation of the input signal and the previously stored noise samples.

The signal bandwidth detector 400 may be designed such that it stops operations of a sub-band filter 410, a restored signal generator 420, and a band pass filter 430 when the detected input signal bandwidth is less than 8 KHz or greater than 16 KHz. When the input signal bandwidth is less than 8 KHz, it is meaningless (i.e., unnecessary) to restore a high frequency component of the input signal, because the input signal is encoded in very low quality. When the input signal bandwidth exceeds 16 KHz, there is no need to restore the high frequency component, because the input signal is encoded with sufficiently high quality so that the high frequency component is not lost.

The sub-band filter 410 splits the input signal bandwidth detected by the signal bandwidth detector 400 into a predetermined number of sub-bands. The sub-band filter 410 may be designed such that it splits a high frequency band exceeding a center frequency of the input signal bandwidth into a predetermined number of sub-bands. When the input signal bandwidth is Fmax, the center frequency is defined as 0.5*Fmax. That is, the sub-bands have frequency components of higher than 0.5*Fmax when the input signal bandwidth is Fmax.

The input signal frequency band is split into multiple sub-bands in order to reduce intermodulation noise generated by a nonlinear processor 421. When a nonlinear operation is performed on the split sub-bands, the intermodulation noise is restricted by the sub-bands. A number of the sub-bands can be determined based on methods that are known in the art. Accordingly, a detailed description of these methods will not be provided here.

The restored signal generator 420 performs the nonlinear operation on the sub-bands split by the sub-band filer 410 to generate high frequency sub-band signals, and respectively applies gains corresponding to high frequency sub-bands to the high frequency sub-band signals to generate restored signals. The restored signal generator 420 may include the nonlinear processor 421 and a harmonic post-processor 422. The nonlinear processor 421 performs a predetermined nonlinear operation on the sub-bands split by the sub-band filter 410 to generate the high frequency sub-band signals. Here, sub-bands having frequency bands that are shifted by the nonlinear operation are defined as the high frequency sub-bands, and signals belonging to the high frequency sub-bands are defined as the high frequency sub-band signals. The restored signal generator 420 can be a half wave rectifier or a full wave rectifier. These rectifiers generate a signal including high frequency components that are higher than the frequency band of an input signal. The high frequency sub-band signals include these high frequency components. However, the restored signal generator 420 is not limited to the half wave rectifier or the full wave rectifier, and can be other components that provide for the intended purposes set forth herein.

The harmonic post-processor 422 applies gains obtained applying a predetermined energy equation to the high frequency sub-band signals generated by the nonlinear processor 421 to generate restored signals. The level of the high frequency sub-band signals is controlled in response to energy levels of the high frequency sub-bands according to the predetermined energy equation. When the energy level of a high frequency sub-band is high, the high frequency sub-band signal corresponding to the high frequency sub-band is amplified with a large gain. Equation 1 (below) can be used as the predetermined energy equation.

The restored signal generator 420 may be designed such that it generates the restored signals with respect to the input signal only when the input signal bandwidth detected by the signal bandwidth detector 400 is greater than 8 KHz and less than 16 KHz. In other words, the restored signal generator 420 may operate when the input signal is encoded with intermediate quality.

The band pass filter 430 filters noise from the restored signals generated by the restored signal generator 420 using frequencies greater than the input signal bandwidth as cutoff frequencies, and transmits the filtered signals to a signal combiner 440. The band pass filter 430 may use the frequency corresponding to the input signal bandwidth and 18 KHz frequency as the cutoff frequencies.

The restored signals are high frequency components existing in a frequency band higher than the input signal frequency band. Accordingly, it is efficient to use a frequency corresponding to the input signal bandwidth as one of the cutoff frequencies of the band pass filter 430. Furthermore, most of the restored signals having frequencies greater than 18 KHz are noise components, and thus it is also efficient to use 18 KHz as one of the cutoff frequencies of the band pass filter 430. When the input signal frequency is 13 KHz, for example, the band pass filter passes only restored signals having frequencies between 13 KHz and 18 KHz, and cuts off the other signals that are not within this range. However, it should be understood that other frequencies besides the input signal frequency and the noise frequency 18 KHz may alternatively be used with the present general inventive concept.

The signal combiner 440 combines the restored signals generated by the restored signal generator 420 and the input signal to generate a target audio signal.

FIG. 4B is a block diagram illustrating the harmonic post-processor 422 of FIG. 4A. Referring to FIG. 4B, the harmonic post-processor 422 may include an energy calculator 423 and a gain application unit 424. The energy calculator 423 can obtain an ith sub-band energy using the following energy equation (i.e., the predetermined energy equation described above).
Eᵢ=Eᵢ₋₁×Eᵢ₋₁/Eᵢ₋₂ [Equation 1]

Here, Eᵢ is the ith sub-band energy, Eᵢ₋₂ is the (i-2)th sub-band energy, and Eᵢ₋₁ is the (i-1)th sub-band energy. Equation 1 can be represented as follows.
Eᵢ/Eᵢ₋₁=Eᵢ₋₁/Eᵢ₋₂ [Equation 2 ]

Equation 2 shows that an energy ratio of adjacent sub-bands is fixed. For example, when the first sub-band energy is twice the second sub-band energy, the second sub-band energy is twice the third sub-band energy.

The gain application unit 424 applies a gain proportional to the ith sub-band energy Eᵢ to a high frequency sub-band signal generated by performing the nonlinear operation on the (i-2)th sub-band of the input signal. That is, the gain application unit 424 controls the level of signals belonging to the ith sub-band such that an energy relationship between neighboring sub-bands satisfies Equation 2.

FIG. 5 is a flow chart illustrating a method of restoring a high frequency component of an audio signal according to an embodiment of the present general inventive concept. The method of FIG. 5 may be performed by the apparatus of FIG. 4A. Referring to FIG. 5, a bandwidth of an input signal is detected according to a correlation between the input signal and previously stored noise samples in operation 500. The input signal bandwidth can be detected more accurately as a number of the noise samples is increased. However, a circuit configuration may become complicated when the number of noise samples is increased.

The detected input signal bandwidth is split into a plurality of sub-bands in operation 510. The number of the sub-bands can be determined by methods known in the art. For example, the input signal bandwidth may be split into two sub-bands, however, the number of the sub-bands is not limited to two and can be other values. As the number of the sub-bands is increased, intermodulation noise generated by a nonlinear operation is decreased; however, a device structure may become complicated.

A nonlinear operation is performed on the sub-bands to generate high frequency sub-band signals, and the level of the high frequency sub-band signals is controlled to generate restored signals in operation 520. The level of the high frequency sub-band signals is controlled based on energy levels of the high frequency sub-bands according to a predetermined energy equation. When the energy level of a high frequency sub-band is large, the corresponding high frequency sub-band signal is amplified with a large gain. Equation 1 (above) can be used as the predetermined energy equation.

When the restored signals are obtained, the input signal and the restored signals are combined to generate a target audio signal in operation 530. The target audio signal includes high frequency components restored using the aforementioned process, and the bandwidth of the target audio signal is made larger than the bandwidth of the input signal.

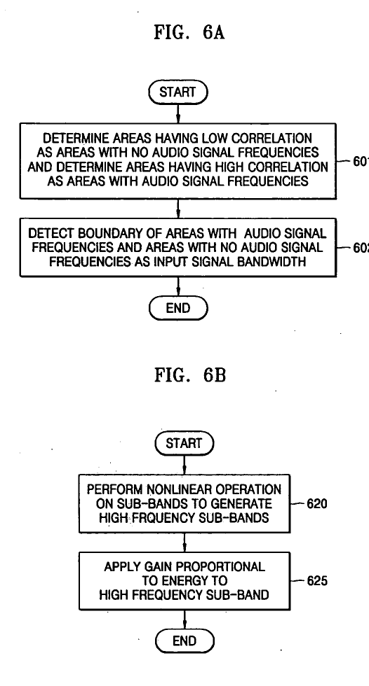

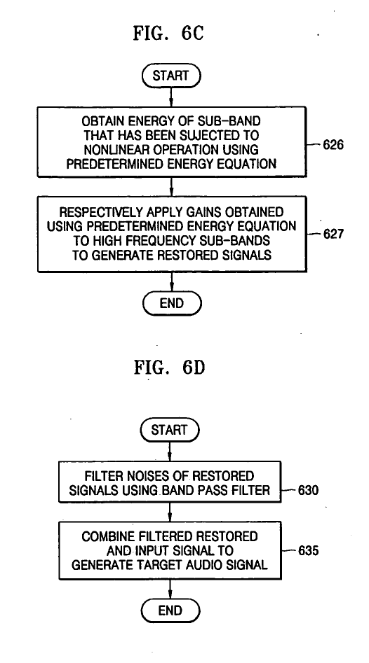

FIG. 6A is a flow chart illustrating the operation 500 of the method of FIG. 5. Referring to FIG. 6A, the correlation of the input signal and previously stored noise samples is obtained, and areas where the correlation is low are determined as areas with no audio signal frequencies, while areas where the correlation is high are determined as areas with audio signal frequencies in operation 601. Then, a boundary between the areas with no audio signal frequencies and the areas with the audio signal frequencies is detected as the bandwidth of the input signal in operation 602.

FIG. 6B is a flow chart illustrating the operation 520 of the method of FIG. 5. Referring to FIG. 6B, a predetermined nonlinear operation is performed on the split sub-bands to generate the high frequency sub-band signals in operation 620. Energy levels respectively corresponding to the high frequency sub-bands are obtained using a predetermined energy equation (i.e., Equation 1 above), and gains proportional to the energy levels are respectively applied to the high frequency sub-band signals to obtain restored signals in operation 625.

FIG. 6C is a flow chart illustrating the operation 625 of FIG. 6B. Referring to FIG. 6C, the energy level of the high frequency sub-bands are obtained using the energy equation such as Equation 1 (above) in operation 626. Here, an energy ratio of neighboring energies may be fixed as represented in Equation 2 (above). That is, a gradient of increasing or decreasing energy between neighboring sub-bands may be fixed. The gains that are proportional to the energy levels of the high frequency sub-bands are respectively applied to the high frequency sub-band signals to amplify or attenuate signals belonging to the high frequency sub-bands to obtain the restored signals in operation 627. That is, the restored signals are obtained by appropriately controlling the level of the signals belonging to the high frequency sub-bands.

FIG. 6D is a flow chart illustrating the operation 530 of the method of FIG. 5. Referring to FIG. 6D, noise of the restored signals are filtered using a band pass filter in operation 630 to remove unnecessary noise that is amplified or newly introduced while the restored signals are obtained. Then, the filtered restored signals and the input signal are combined to generate the target audio signal in operation 635.

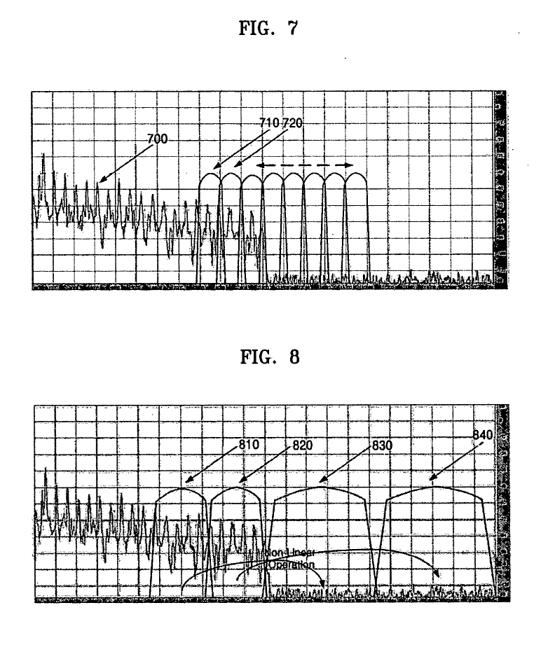

FIG. 7 is a graph illustrating an input signal 700 and noise samples 710 and 720 used in the operation 500 of the method of FIG. 5.

In FIG. 7, the horizontal axis represents a spectrum frequency (Hz) and the vertical axis represents a spectrum level (dB). FIG. 7 illustrates that an area where the input signal 700 exists is distinct from an area where the input signal 700 does not exist. Small waveforms existing in the area having no input signal correspond to white noise. The noise samples 710 and 720 used to detect the bandwidth of the input signal 700 are obtained by splitting general white noise into signals each having a specific bandwidth. That is, the noise samples 710 and 720 are irrelevant to the input signal 700. The bandwidth of the input signal 700 can be detected more accurately as the bandwidth of the noise samples is made narrower and the number of the noise samples is made larger.

Correlation between the noise samples 710 and 720 and the input signal 700 is high in the area having the input signal 700, but the correlation is low in the area having no input signal 700. In the graph of FIG. 7, the bandwidth of the input signal 700 is slightly higher than 11 KHz.

FIG. 8 is a graph illustrating sub-bands 810 and 820 on which the nonlinear operation is performed to obtain high frequency sub-band signals 830 and 840 in the operations 510 and 520 of the method of FIG. 5. The horizontal axis represents a spectrum frequency (Hz) and the vertical axis represents a spectrum level (dB).

Referring to FIG. 8, the sub-bands 810 and 820 that are not subjected to the nonlinear operation are located at frequencies higher than the center frequency of the input signal. When the nonlinear operation is performed on the sub-bands 810 and 820, the high frequency sub-band signals 830 and 840 having frequencies higher than the input signal bandwidth are generated. The level of the signals belonging to the high frequency sub-bands 830 and 840 is appropriately controlled to obtain restored signals. The restored signals are amplified or attenuated such that the energies of the high-frequency sub-bands 830 and 840 satisfy Equation 1 (above).

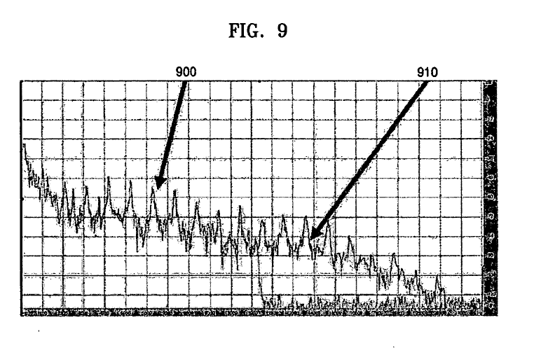

FIG. 9 is a graph illustrating an audio signal restored according to an embodiment of the present general inventive concept. The horizontal axis represents a spectrum frequency (Hz) and the vertical axis represents a spectrum level (dB). Restored signals and an input signal 900 are combined to obtain a target audio signal having restored high frequency components 910. In FIG. 9, signals having frequencies higher than 11 KHz are signals restored according to the present embodiment.

The sub-bands may have only high frequency components that are higher than the center frequency of the input signal bandwidth.

The present general inventive concept may be embodied as a computer program and the computer program may be stored in a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

The apparatus to restore a high frequency component of an audio signal according to embodiments of the present general inventive concept may be applied to a portable audio player.

The apparatus to restore a high frequency component of an audio signal according to embodiments of the present general inventive concept may be applied to an audio reproducing device using an audio compression CODEC having a high frequency component loss.

As described above, according to the various embodiments of the present general inventive concept, a bandwidth of an input signal is correctly detected with a simple device configuration, and optimized signal processing is performed on the detected input signal bandwidth to restore lost high frequency components. Accordingly, an apparatus to restore a high frequency component of an audio signal can be easily constructed without an adaptive filter having a complicated structure, and the high frequency component restoring apparatus is easily applied to small portable devices.

Furthermore, the various embodiments of the present general inventive concept can control a level of restored signals in response to energy levels of sub-bands, and thus, a shape or a slope of a spectrum envelope can accord with an original audio signal. Accordingly, optimized audio quality can be obtained from an input signal from which a high frequency component has been lost or removed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of restoring a high frequency component of an audio signal, the method comprising:
detecting a bandwidth of an input signal according to a correlation between the input signal and one or more previously stored noise samples;
splitting the detected input signal bandwidth into a predetermined number of sub-bands;
controlling a level of high frequency sub-band signals generated by performing a predetermined nonlinear operation on the split sub-bands, in response to energy levels of high frequency sub-bands obtained when the nonlinear operation is performed on the split sub-bands to obtain restored signals; and
combining the restored signals and the input signal to generate a target audio signal.

2. The method of claim 1, wherein the detecting of the input signal bandwidth comprises:
determining areas where the correlation is less than a reference value as areas with no audio signal frequencies and determining areas where the correlation is greater than the reference value as areas with audio signal frequencies; and
detecting a boundary between the areas with no audio signal frequencies and the areas with the audio signal frequencies as the bandwidth of the input signal.

3. The method of claim 1, wherein the splitting of the detected input signal bandwidth into the predetermined number of sub-bands comprises splitting high frequency bands higher than a center frequency of the detected input signal bandwidth into the predetermined number of sub-bands.

4. The method of claim 1, wherein the obtaining of the restored signals comprises generating restored signals with respect to the input signal only when the detected input signal bandwidth is higher than 8 KHz and lower than 16 KHz.

5. The method of claim 1, wherein the obtaining of the restored signals comprises:
performing the predetermined nonlinear operation on the split sub-bands to generate the high frequency sub-band signals; and
respectively applying gains obtained using a predetermined energy equation to the high frequency sub-band signals to control the level of the high frequency sub-band signals based on the energy levels of the high frequency sub-bands.

6. The method of claim 5, wherein the controlling of the level of the high frequency sub-band signals comprises:
obtaining an energy Eᵢ of an ith sub-band of the input signal from an energy Eᵢ₋₂ of an (i-2)th sub-band and an energy Eᵢ₋₁ of an (i-1)th sub-band of the input signal using an energy equation of Eᵢ=Eᵢ₋₁×Eᵢ₋₁/Eᵢ₋₂; and
applying a gain proportional to the energy Eᵢ of the ith sub-band to high frequency sub-band signals generated by performing the predetermined nonlinear operation on the (i-2)th sub-band of the input signal to generate the restored signals.

7. The method of claim 1, wherein the generating of the target audio signal comprises:
filtering noise from the restored signals using a band pass filter using frequencies higher than the input signal bandwidth as cutoff frequencies; and
combining the filtered signals and the input signal to generate the target audio signal.

8. A computer readable recording medium storing a program executing a method of restoring a high frequency component of an audio signal, the medium comprising:
executable code to detect a bandwidth of an input signal according to a correlation between the input signal and one or more previously stored noise samples;
executable code to split the detected input signal bandwidth into a predetermined number of sub-bands;
executable code to control a level of high frequency sub-band signals generated by performing a predetermined nonlinear operation on the split sub-bands, in response to energy levels of high frequency sub-bands obtained when the nonlinear operation is performed on the split sub-bands to obtain restored signals; and
executable code to combine the restored signals and the input signal to generate a target audio signal.

9. An apparatus to restore a high frequency component of an audio signal, the apparatus comprising:
a signal bandwidth detector to detect a bandwidth of the input signal according to a correlation between the input signal and one or more previously stored noise samples;
a sub-band filter to split the detected input signal bandwidth into a predetermined number of sub-bands;
a restored signal generator to control a level of high frequency sub-band signals generated by performing a predetermined nonlinear operation on the split sub-bands, in response to energy levels of the high frequency sub-bands to obtain restored signals; and
a signal combiner to combine the restored signals and the input signal to generate a target audio signal.

10. The apparatus of claim 9, wherein the signal bandwidth detector comprises:
a correlation calculator to calculate the correlation between the input signal and the previously stored noise samples; and
a result processor to determine areas where the correlation is less than a reference value as areas with no audio signal frequencies, to determine areas where the correlation is greater than the reference value as areas with audio signal frequencies, and to detect a boundary between the areas with no audio signal frequencies and the areas with the audio signal frequencies as the bandwidth of the input signal.

11. The apparatus of claim 9, wherein the sub-band filter splits high frequency bands higher than a center frequency of the detected input signal bandwidth into the predetermined number of sub-bands.

12. The apparatus of claim 9, wherein the restored signal generator generates the restored signals with respect to the input signal only when the detected input signal bandwidth is higher than 8 KHz and lower than 16 KHz.

13. The apparatus of claim 9, wherein the restored signal generator comprises:
a nonlinear processor to perform the predetermined nonlinear operation on the split sub-bands to generate the high frequency sub-band signals; and
a harmonic post-processor to respectively apply gains obtained using a predetermined energy equation to the high frequency sub-band signals to control the level of the high frequency sub-band signals based on the energy levels of the high frequency sub-bands.

14. The apparatus of claim 13, wherein the harmonic post-processor comprises:
an energy calculator to obtain an energy Eᵢ of an ith sub-band of the input signal from an energy Eᵢ₋₂ of an (i-2)th sub-band and an energy Eᵢ₋₁ of an (i-1)th sub-band of the input signal using an energy equation of Eᵢ=Eᵢ₋₁×Eᵢ₋₁/Eᵢ₋₂; and
a gain application unit to apply a gain that is proportional to the energy Eᵢ of the ith sub-band to high frequency sub-band signals generated by performing the nonlinear operation on the (i-2)th sub-band of the input signal to generate the restored signals.

15. The apparatus of claim 9, further comprising:
a band pass filter to filter noise of the restored signals generated by a harmonic post-processor using frequencies higher than the input signal bandwidth as cutoff frequencies and to transmit the filtered restored signals to the signal combiner.

16. The apparatus of claim 15, wherein the band pass filter uses the frequency corresponding to the input signal bandwidth and 18 KHz as the cutoff frequencies.

17. A high frequency restoring apparatus, comprising:
a signal bandwidth detector to detect a signal bandwidth of an input audio signal; and
a restored signal generator to derive a high frequency band from audio data in the detected signal bandwidth and to adjust a shape of a spectrum of the high frequency band to match a spectrum envelope of the input audio signal.

18. The apparatus of claim 17, wherein the restored signal generator adjusts the spectrum envelope by determining energy levels of a plurality of bands in the high frequency bands and apply corresponding gains to the determined energy levels.

19. The apparatus of claim 17, wherein the signal bandwidth detector detects the signal bandwidth by comparing at least one predetermined noise sample to at least one portion of the input audio signal to determine a frequency point at which audio data of the input audio signal is lost.

20. The apparatus of claim 19, wherein the signal bandwidth detector calculates a correlation between the at least one predetermined noise sample and the at least one portion of the input audio signal and determines the signal bandwidth as the frequency at which point the correlation changes from being higher than a reference value to being lower than the reference value.

21. The apparatus of claim 17, wherein the restored signal generator divides the signal bandwidth into a plurality of sub-bands, derives a plurality of high frequency sub-bands from the plurality of sub-bands, determines energy levels of the high frequency sub-bands, and applies corresponding gains to the determined energy levels.

22. The apparatus of claim 17, further comprising:
a signal combiner to combine the input audio signal with the derived high frequency band.

23. The apparatus of claim 17, further comprising:
a band pass filter to receive the derived high frequency band and to pass frequencies between a low limit frequency determined by a maximum frequency of the signal bandwidth and an upper limit frequency set to about 18 KHz.

24. A portable audio player, comprising:
a high frequency component restoring apparatus to receive an input audio signal, to calculate a bandwidth of the input audio signal by comparing predetermined noise patterns with a frequency spectrum of the input audio signal, to derive high frequency sub bands above a center frequency of the input audio signal by applying a nonlinear operation to sub bands in the bandwidth of the input audio signal, and to adjust a level of the high frequency sub bands in response to energy levels of the high frequency sub bands to provide a high frequency component; and
an output part to combine the input audio signal with the high frequency component and output the combined audio signal.

25. A coder-decoder apparatus, comprising:
a high frequency component restoring apparatus to receive an input audio signal, to calculate a bandwidth of the input audio signal by comparing predetermined noise patterns with a frequency spectrum of the input audio signal, to derive high frequency sub bands above a center frequency of the input audio signal by applying a nonlinear operation to sub bands in the bandwidth of the input audio signal, and to adjust a level of the high frequency sub bands in response to energy levels of the high frequency sub bands to provide a high frequency component; and
an output part to combine the input audio signal with the high frequency component and output the combined audio signal.
